(19) United States
(12) Patent Application Publication
(10) Pub. No.: US 2004/0013198 A1
(43) Pub. Date: Jan. 22, 2004

(54) Encoding apparatus and method for encoding

(76) Inventors: Haruo Togashi, Kanagawa (JP); Seiji Kawa, Kanagawa (JP)

Correspondence Address: FROMMER LAWRENCE & HAUG, 745 FIFTH AVENUE- 10TH FL., NEW YORK, NY, 10151, US

(21) Appl. No.: 10/230,461

(22) Filed: Aug. 29, 2002

(30) Foreign Application Priority Data
Aug. 31, 2001 (JP) 2001-264577

(51) Int. Cl. H04B 1/66; H04N 7/12; H04N 11/02

(52) U.S. Cl. 375/240.12

(57) ABSTRACT

In the invention, high quality image data can be encoded using encoders, which are originally designed for encoding image data of ordinary image quality. This can be done by intra-encoding Video In signal supplied from input circuit by two encoders when SDI In signal is an HD signal. An entire picture area is divided into a first group and a second group of divisional picture domains, which are distributed over the picture area. The centers of gravity of the respective groups substantially coincide. An encoder encodes image data extracted corresponding to the first group from active video data of Video In signal, while the other encoder encodes image data extracted corresponding to the second group from the active video data of Video In signal. The resultant MPEG signals output from the respective encoders are combined to form a stream.

### BACKGROUND OF THE INVENTION

1. Field of the Invention

The invention relates to an encoding apparatus for encoding data, such as image data, and more particularly, to an encoding apparatus for encoding the image data for compression according to MPEG standards and performing other procedures. The invention further relates to a method for encoding such the image data.

2. Description of Related Art

Image data recording apparatus has been proposed in conventional technique that after input image data is illustratively MPEG encoded for compression, the data thus encoded is added with error correction bits and modulated to form a recording signal, and then, such the signal is recorded on a storage medium such as a recording tape or disk.

An encoding apparatus for receiving input signals called HIGH definition (HD) signals, complying with 1125/60i signal standard, for example, has an enormous circuit arrangement, and hence is expensive, as compared with an encoding apparatus for receiving input signals called standard definition (SD) signals, complying with 525/60i signal standard. Here, the 1125/60i signal is an image signal for an interlacing frame having 1125 lines and a field frequency of 60 Hz. The 525/60i signal is an image signal for an interlacing frame having 525 lines and a field frequency of 60 Hz.

Such an encoding scheme has already been proposed (see, for example, Japanese Laid-Open Patent Publication H11-234678) that when input image data is the one according to the HD signal, a picture area is divided into a multiplicity of divisional picture domains, and separate SD signal encoders respectively encode image data extracted from input image data with the extracted image data corresponding to each divisional picture domain, this allows small-sized, less expensive SD signal encoders to be utilized even when the input image data is the one according to the HID signal.

However, when a target encoding task is uniformly allocated to each of the SD signal encoders as mentioned above that encode the image data corresponding to each divisional picture domain, this often results in following cases: some SD signal encoders must encode the image data even if a picture quality thereof is degraded in order to process much complex image portion in the picture area and the others have too enough margins for encoding to entirely utilize their encoding capacity. Should such the cases occur, peripheral boundaries of the respective divisional picture domains appear conspicuously.

It is therefore an object of the invention to provide an encoding apparatus and an encoding method therefor in which the encoders are available to encode the image data on which an image with an ordinary image quality is based without any appearance of the conspicuous peripheral boundaries of the respective divisional picture domains.

### SUMMARY OF THE INVENTION

In accordance with one aspect of the invention, there is provided an encoding apparatus for encoding input image data to obtain encoded output image data. The encoding apparatus comprises first through Nth encoders and a data combiner. Each encoder extracts image data from the input image data and intra-encodes the image data. The extracted image data corresponds to each of the first through Nth groups each having multiple divisional picture domains in a given picture area. The multiple divisional picture domains of every group are distributed over the picture area. Each of the first through Nth groups of the divisional picture domains occurs in turn within the picture area. The data combiner receives the intra-encoded image data from each of the first through Nth encoders and combines the received intra-encoded image data to obtain the encoded output image data.

In accordance with another aspect of the invention, there is provided a method for encoding input image data to obtain encoded output image data. The method comprises the steps of extracting image data from the input image data, intra-encoding the image data thus extracted every first through Nth groups each having multiple divisional picture domains in a given picture area, and combining the data thus intra-encoded ever groups to obtain the encoded output image data. The extracted image data also corresponds to each of the first through Nth groups of multiple divisional picture domains in a given picture area. The multiple divisional picture domains of every group are also distributed over the picture area. Each of the first through Nth groups of multiple divisional picture domains occurs in turn within the picture area.

According to the invention, the first through Nth encoders for intra-encoding the image data are provided. The first through Nth encoders intra-encode the image data extracted from the input image data with the extracted image data corresponding to each of the first through Nth groups. Each of the groups comprises plural divisional picture domains that are distributed over the entire picture area. Encoded output data is obtained by combining first through Nth intra-encoded data obtained under the intra-encoding.

In this manner, according to the invention, the first through Nth encoders execute intra-encoding on the image data extracted from the input image data with the extracted image data corresponding to each of the first through Nth groups each having multiple divisional picture domains which are distributed over the entire picture area. Therefore, small and cost saving SD encoders may be used in encoding the input image data if the data is the one according to HD signal, for example.

Further, according to the invention, the first through Nth encoders intra-encode the image data extracted from the input image data with the extracted image data corresponding to each of the first through Nth groups each having multiple divisional picture domains which are distributed over the entire picture area. Thus, this results in the image data on which each of the image portions with similar complexity are based, and the above first through Nth encoders intra-encode such the image data in parallel with each other. Therefore, each encoder encodes the image data in parallel with each other to obtain the image with similar image quality if a target encoding task is uniformly allocated to each of the encoders, thereby preventing therefrom undesirable conspicuous peripheral boundaries of the divisional picture domains.

In accordance with a still further aspect of the invention, there is provided an encoding apparatus for encoding input image data to obtain encoded output image data. This encoding apparatus comprises first and second encoders each for intra-encoding image data, a controller, and an encoded-image-data-outputting device. The controller controls the first and second encoders. When the input image data is of a first picture quality, the controller causes the first encoder to intra-encode the input image data. When said input image data is of a second picture quality higher than the first picture quality, the controller causes the first and second encoders to intra-encode the image data extracted from the input image data with the extracted image data corresponding to each of the first and second groups. Each group has multiple divisional picture domains of a picture area. The multiple divisional picture domains of both groups are distributed over the picture area. Each of the first and second groups of multiple divisional picture domains occurs in turn within the picture area. When the input data is of the first picture quality, the encoded-image-data-outputting device outputs as the encoded output image data the encoded data received from the first encoder. When the input image data is of the second picture quality, the encoded-image-data-outputting device combines the encoded data received from the first and second encoders and outputs as the encoded output image data the combined data.

In accordance with still another aspect of the invention, there is provided a method for encoding input image data to obtain encoded output image data. The method comprises intra-encoding step and outputting step. When the input data is of a first picture quality, the input image data is intra-encoded and then, the intra-coded data is output as the encoded output image data. When the input image data is of a second picture quality higher than the first picture quality, image data extracted from the input image data is intra-encoded for each of the first and second groups with the extracted image data corresponding to each of the first and second groups. Each group has multiple divisional picture domains of a picture area. The multiple divisional picture domains of the first and second groups are distributed over the picture area. Each of the first and second groups of multiple divisional picture domains occurs in turn within the picture area. Then, when the input image data is of the second picture quality, the data thus intra-coded is combined by each group and the combined data is output as the encoded output data.

This encoding apparatus is equipped with the first and second encoders each for intra-encoding given image data.

When the input image data, e.g. SD signal, is of a first picture quality, the first encoder intra-encodes the input image data, thereby providing the resultant data as the encoded output image data.

When the input image data, e.g. HD signal, is of a second picture quality, the first and second encoders intra-encode image data extracted from the input image data with extracted image data corresponding to each of the first and second groups. The multiple divisional picture domains of each group are distributed over the picture area. Each of the first and second groups has multiple divisional picture domains of a picture area. The multiple divisional picture domains of the first and second groups are distributed over the picture area. Each of the first and second groups of multiple divisional picture domains occurs in turn within the picture area. The resultant intra-encoded data obtained for the respective groups are combined and outputted as the encoded output data.

Thus, when the image data (e.g. SD signal) is of a first picture quality, the first encoder intra-encodes the input image data. When the input image data (e.g. H) signal) is of a second picture quality, the first and second encoders intra-encode the image data extracted from the input image data with the extracted image data corresponding to each of the first and second groups. Accordingly, desired recording data can be obtained through appropriate encoding irrespective of whether the input image data is of the first picture quality or of the second picture quality. Therefore, in encoding image data of the second quality, the invention permits use of compact and less expensive encoder for input image data of the first picture quality for appropriate encoding.

In encoding input image data of the second picture quality, the first and second encoders respectively intra-encode the image data extracted from the input image data corresponding to each of the first and second groups of multiple divisional picture domains, which are distributed over the entire picture area. Thus, this results in the image data on which each of the image portions with similar complexity are based, and the above first and second encoders intra-encode such the image data in parallel with each other. Therefore, each encoder encodes the image data in parallel with each other to obtain the image with similar image quality if a target encoding task is uniformly allocated to each of the encoders, thereby preventing therefrom undesirable conspicuous peripheral boundaries of the divisional picture domains.

### BRIEF DESCRIPTION OF THE DRAWINGS

The invention will now be described in detail by way of example with reference to accompanying drawings, in which:

FIG. 1 is a block diagram representing an arrangement of an MPEG-VTR as an embodiment according to the invention;

FIG. 2 is a block diagram showing an arrangement of an MPEG encoder for use in the MPEG-VTR of FIG. 1;

FIG. 3 shows video input signals in accord with 525/60i standard;

FIG. 4 shows video input signals in accord with 1125/60i standard;

FIG. 5 shows exemplary divisions of a picture area, specifically, FIG. 5A showing an example of vertically divisional picture domains, FIG. 5B showing an example of horizontally divisional picture domains, and FIG. 5C showing an example of horizontally as well as vertically divisional picture domains; and

FIG. 6 is a diagram for describing a sub-block for calculating the activity of a first field.

### BEST MODE FOR CARRYING OUT THE INVENTION

Embodiments of this invention will be described with reference to accompanying drawings.

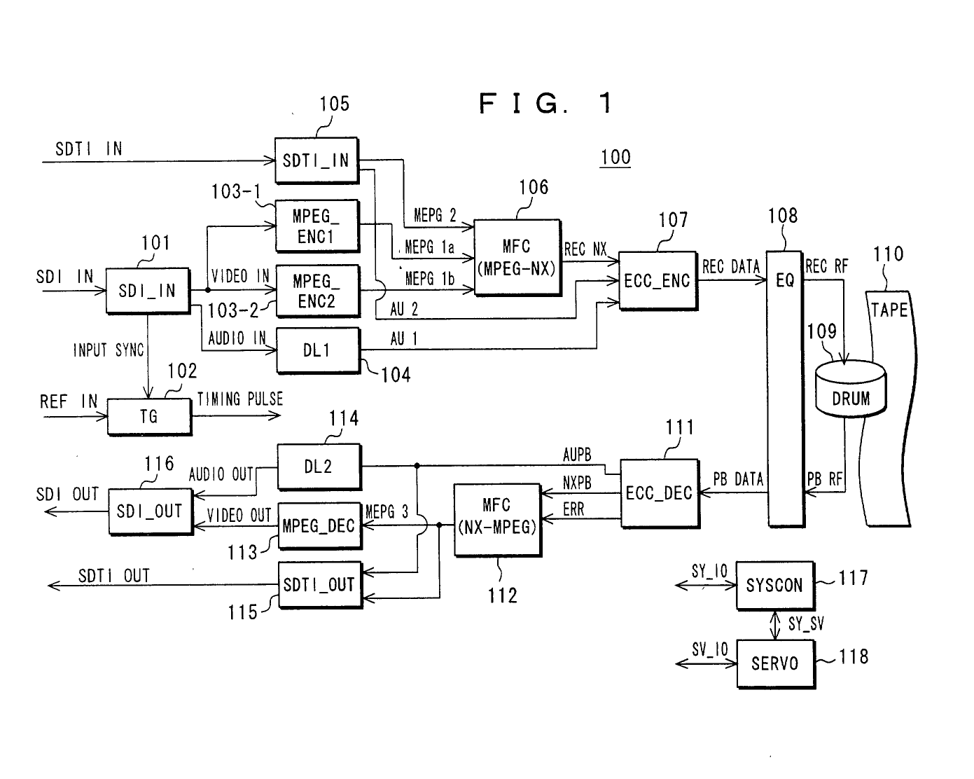

FIG. 1 shows an arrangement of an MPEG-VTR 100 as an embodiment according to this invention.

First, the structure and operations of a recording system of the MPEG-VTR 100 encoder will be described.

External signals entered into the recording system include two kinds of serial digital interface signal, i.e. SDI In signal and SDTI In signal, and an external reference signal REF In which will serve as a control signal. The SDI In signal and SDTI In signal are multiplex signals containing a video signal and an audio signal. The SDTI In signal is compressed, but the SDI In signal is not compressed. In the embodiment shown herein, the SDI In signal and SDTI In signal assume SD signal (according to 525/60i signal standard) and HD signal (according to 1125/60i signal standard), respectively.

The SDI In signal is input to an input circuit (SDI IN) 101. The input circuit 101 converts the serial SDI In signal to a parallel counterpart, and it transfers to a timing generator (TG) 102 an input synchronizing signal (Input Sync) contained in the SDI In signal, which signal is a phase reference.

The input circuit 101 separates a video signal and an audio signal from the converted parallel signal, and feed the video input signal Video In and the audio input signal Audio In to MPEG encoders (MPEG_ENC) 103-1 and 103-2 and to a delay circuit (DL1) 104.

The timing generator (TG) 102 provides a timing signal in the form of timing pulse necessary for VTR to the respective blocks in synchronism with either the reference synchronization signal (Reference Sync) extracted from received reference signal REF In or the input synchronization signal (Input Sync) received from the input circuit 101.

The MPEG encoders 103-1 and 103-2 respectively compress the video input signals they received through a DCT conversion, quantization, variable-length encoding to generate respective MPEG elementary streams MPEG1a and MPEG1b to be supplied to a MPEG format converter circuit (MFC) circuit 106 as a data combiner.

The MPEG encoders 103-1 and 103-2 are controlled by a system controller (SYSCON) 117 as will be described in detail later. When the SDI In signal is an SD signal (according to 525/60i signal standard), only MPEG encoder (MPEG_ENC1) 1031 intra-encodes the active video data of the video input signal (Video In).

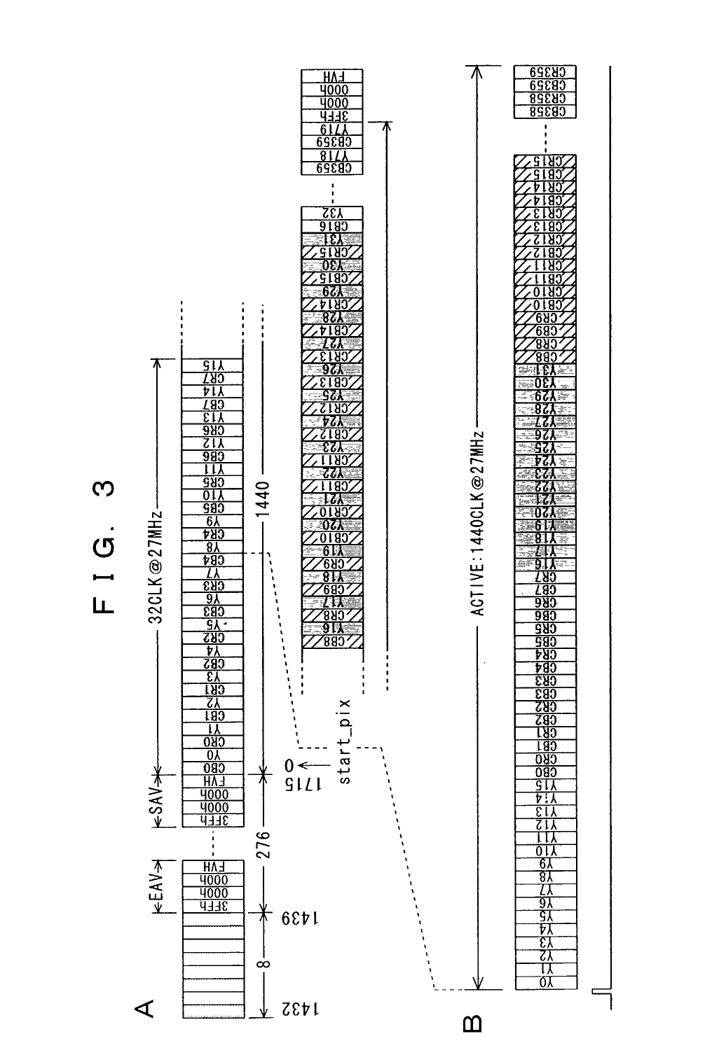

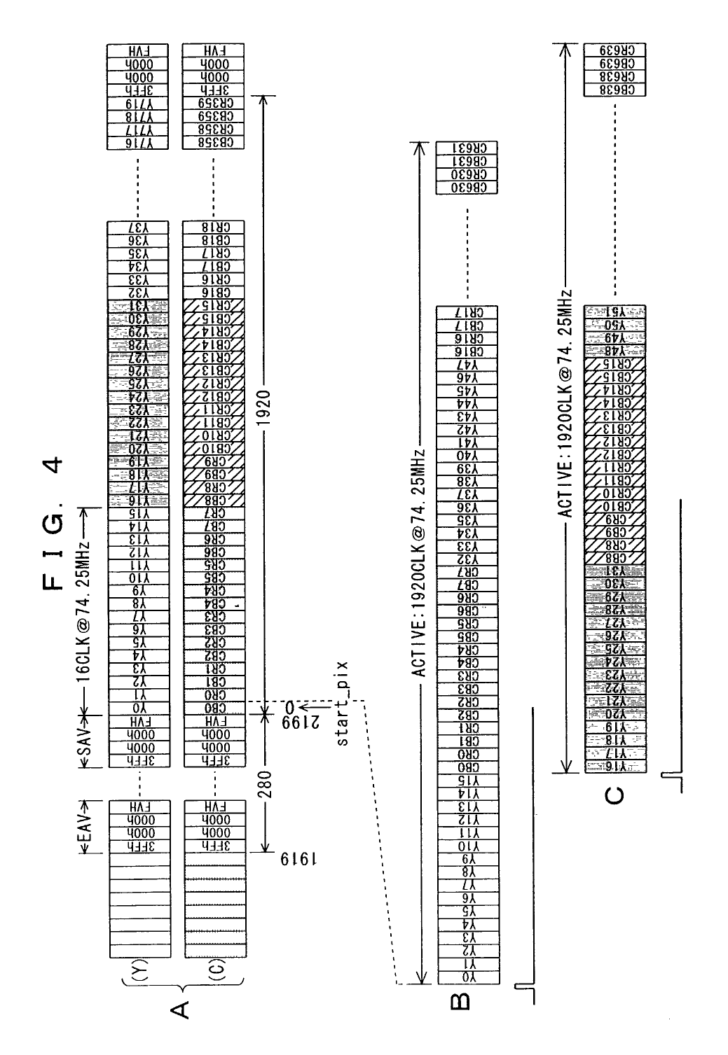

Referring to FIG. 3, “A” shows video input signal (Video In) according to 525/60i signal standard and B shows a data format of its active video data which is extracted from the video input signal (Video In) by the input stage of the MPEG encoder 103-1 and processed by the subsequent stage of the MPEG encoder 103-1. As will be apparent from FIG. 3, the active video data extracted by the input stage of the MPEG encoder 103-1 and processed by the subsequent stage thereof are reordered against the active video data of the video input signal (Video In). This reordering helps simplify the encoding by the MPEG encoder 103-1. It is noted that in the signal A of FIG. 3, SAV (Start of Active Video) is a data indicating the start of a line and EAV (End of Active Video) indicating the end of the line. The same is true also in FIG. 4 described later.

When the SDI In signal complies with HD signal (according to 1125/60i signal standard), the MPEG encoder (MPEG_ENC1) 103-1 and MPEG encoder (MPEG_ENC2) 103-2 intra-encode SDI In signal.

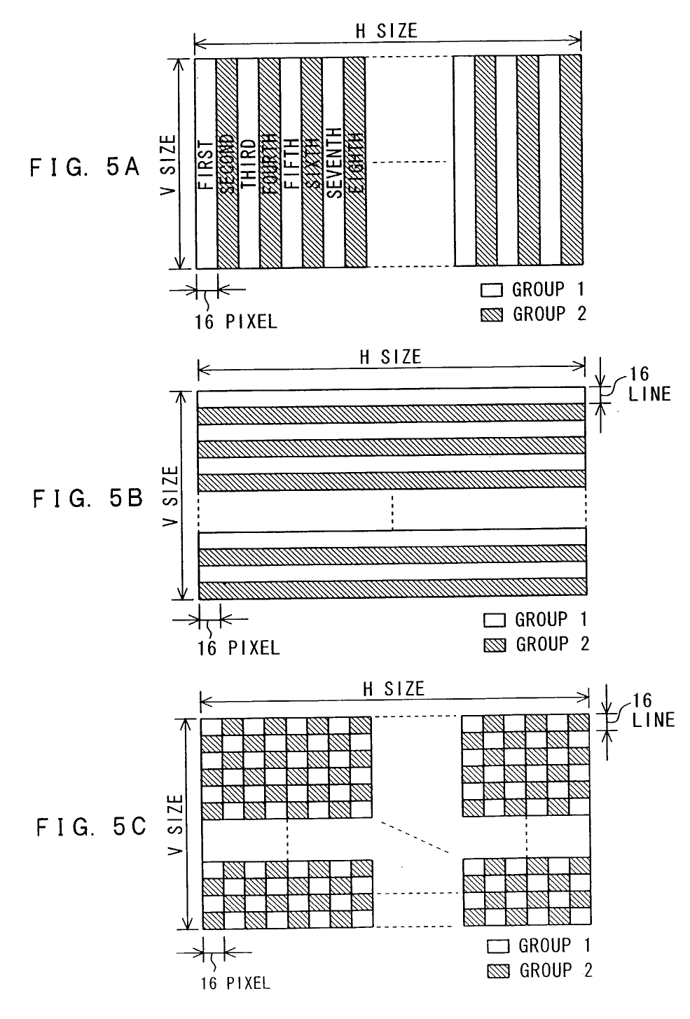

In the embodiment shown herein, the picture area is vertically divided into two groups (group 1 and 2) each having multiple interlaced divisional domains having a width of 16 pixels in a horizontal direction, with the domains of each group not neighboring each other and distributed over the entire picture area, as shown in FIG. 5A. The group 1 consists of first, third, fifth, . . . divisional domains in the horizontal direction and the group 2 consists of second, fourth, sixth, . . . divisional domains in the horizontal direction.

The MPEG encoder 103-1 intra-encodes the data belonging to the group 1 extracted from the active video data of the video input signal Video In. On the other hand, the MPEG encoder 103-2 intra-encodes the data belonging to the group 2 extracted from the active video data of the video input signal Video In.

In FIG. 4, “A” shows a video input signal (Video In) which complies with 1125/60i signal standard. The video input signal (Video In) consists of luminance data Y and color data C. In FIG. 4, B shows active video data extracted from the video input signal (Video In) by the input stage of the MPEG encoder (MPEG_ENC1) 103-1 and processed by the subsequent stage thereof. In FIG. 4, C shows active video data extracted from the video input signal (Video In) by the input stage of the 103-2 and processed by the subsequent stage thereof.

The delay circuit (DL1) 104 receives uncompressed audio signals (Audio In) and works as a delay line for delays the audio signals (Audio In) to match its delays with the delays of the input video signals in the both lines associated with the MPEG encoders (MPEG_ENC) 103-1 and 103-2. The delay circuit (DL1) 104 transfers output signal (AU1) to an ECC encoder (ECC_ENC) 107. This is because the MPEG-VTR of the present embodiment processes uncompressed audio signals.

On the other hand, the SDTI In signal is fed to an input circuit (SDTI_IN) 105. The input circuit 105 separates an MPEG elementary stream of MPEG2 signals and audio (AU2) signals from the SDTI In signal and outputs them to the MFC circuit 106 and the ECC encoder (ECC_ENC) 107, respectively.

Thus, it is possible in this arrangement to directly input the MPEG elementary stream to the inventive MPEG-VTR 100, independently of base band image signals supplied from a serial-digital interface.

The MFC circuit 106 selects as its input signal either MPEG1a signal and MPEG1b signal, or MPEG G2 signal, and then reorders the coefficients of the selected MPEG elementary stream in the ascending order in frequency. When the MPEG 1a signal and MPEG1b signals are selected as the input signals, the MFC circuit 106 integrates them into one MPEG elementary stream and reorder the coefficients of the stream as described above.

The reordering or rearrangement of MPEG compressed data by the MFC circuit 106 allows picking up as many DC coefficients and low order AC coefficients as possible during a search reproduction, thereby reproducing a searching image of satisfactory quality during the search reproduction. In this way, input signal is converted into a video signal (REC NX) having an arrangement suitable for VTR before it is output to the encoder (ECC_ENC) 107.

The ECC encoder (ECC_ENC) 107 receives the video signal (REC NX) suitable for VTR and uncompressed audio signals AU1 and AU2 as input signals, executes error correction coding on these signals, and transfers the resultant signals to an equalizer (EQ) 108 as a recording data (REC DATA).

The equalizer (EQ) 108 converts the received recording data (REC DATA) into a recording RF signal (REC RF), and supplies it to a rotational drum (DRUM) 109. The recording RF signal (REC RF) thus constructed is stored on a recording tape (TAPE) 110 by means of a recording head (not shown) mounted on the rotational drum (DRUM) 109.

Next, arrangement and operations of a reproduction system of the present MPEG-VTR 100 will now be described.

During the reproduction, play back RF signal (PB RF) is input from the recorded tape (TAPE) 110 to the equalizer (EQ) 108 via a reproducing head (not shown) mount on the rotational drum (DRUM) 109.

The equalizer (EQ) 108 receives the play back RF signal (PB RF), performs a phase equalization processing and the like on the RF signal (PB RF), and supplies the resultant play back data (PB DATA) to an ECC decoder (ECC_DEC) 111.

The ECC decoder (ECC_DEC) 111 receives the play back data (PB DATA), performs an error correction decoding on the play back data (PB DATA), and transfers a reproduction video signal (NX PB) having a suitable coefficients and structure for VTR to a MFC circuit 112, and an uncompressed play back audio signal (AU PB) to a delay circuit (DL2) 114 and an output circuit (SDT1_OUT) 115, respectively.

In cases where an error exceeds the error correction capability to restore correct data, the ECC decoder (ECC_DEC) 111 provides the MFC circuit 112 with an ERR signal which indicates that the data includes uncorrectable errors.

The MFC circuit 112 receives reproduction video signal (NX PB) having coefficients and structures suitable for VTR, rearranges the signals (NX PB) to the signals having MPEG format in order to improve the reproduction of a searching image of satisfactory quality, reconstructing a MPEG Elementary stream (MPEG3), and supplies it to the MPEG decoder (MPEG_DEC) 113 and an output circuit (SDT1_OUT) 115, respectively.

If at this stage, the MFC circuit 112 receives the ERR signal indicating that the input signal has an error, the MFC circuit 112 replaces the input data with data which perfectly follows the MPEG standard prior to transferring the data.

The MPEG decoder (MPEG_DEC) 113 also receives the MPEG3 signal and decodes it to the uncompressed original video signal (Video Out) prior to transferring the signal to an output circuit (SDI_OUT) 116.

The delay circuit (DL2) 114 receives the audio signal (AU PB) and adjusts timing of the audio signal (AU PB) and timing of the reproduction video signal prior to transferring the signal (AUDIO OUT) thus adjusted to the output circuit (SDI OUT) 116.

The output circuit (SDTI_OUT) 115 receives the timed audio signal (AU PB) and MPEG3 signal, maps them onto a serial-digital compression interface (SDTI) to convert the parallel signal into a corresponding serial signal, and outputs it as resultant compressed output signals (SDTI OUT).

The output circuit (SDI_OUT) 116 receives the timed video signal (VIDEO OUT) and audio signal (AUDIO OUT), maps them onto the serial-digital interface to convert the parallel signals into a serial signal to be output therefrom as an uncompressed output signal (SDI OUT).

In both of the recording system and the reproduction system, the system controller (SYSCON) 117 and a servo control section (SERVO) 118 communicate with each other through exchange of a system servo synchronization signal (SY_SV), and communicate with other blocks by exchanging input/output signals (SY_IO, SV_IO), thereby providing an optimum control of the MPEG-VTR 100.

Next, arrangements and operations of the above MPEG encoders (MPEG ENC) 103-1 and 103-2 will be described.

The MPEG encoders (MPEG_ENC) 103-1 and 103-2 will be described more in detailed.

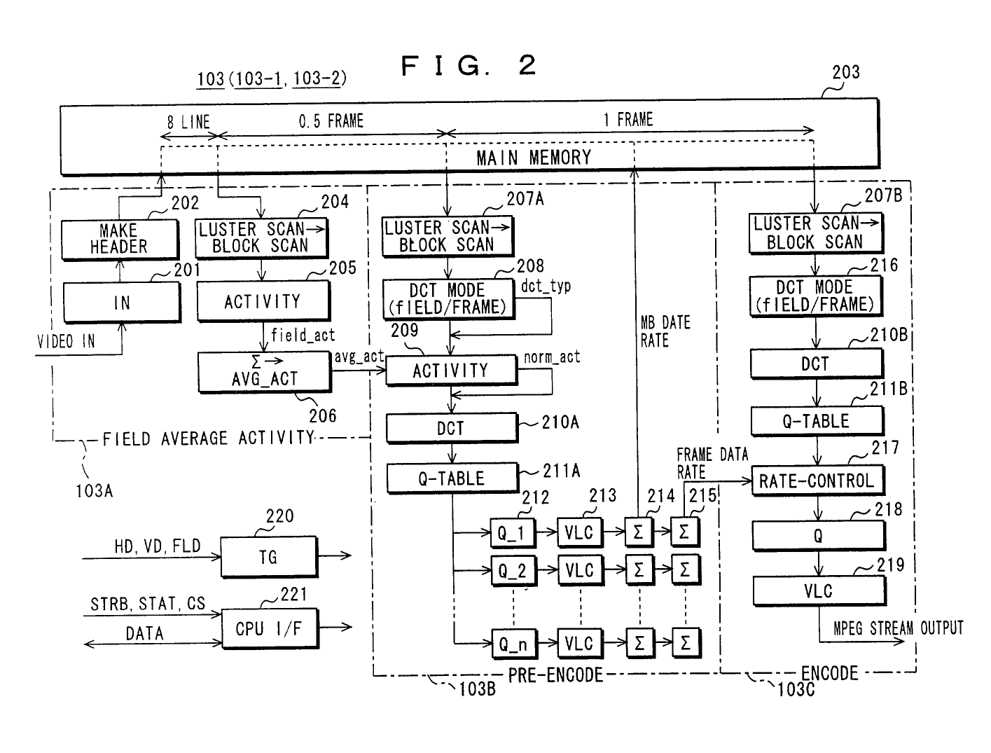

FIG. 2 is a block diagram showing an arrangement of MPEG encoder 103 (103-1 and 103-2). The MPEG encoder 103 includes an input and field activity averaging section 103A, a pre-encoding processing section 103B, and an encoding processing section 103C.

First, the input and field activity averaging section 103A will be described.

An input (IN) block 201 receives video (VIDEO IN) data and converts it to data having appropriate format suitable for storage in a main memory (MAIN MERORY) 203. The input (IN) block 201 extracts activity video data from the received video data (VIDEO IN) to be processed in the subsequent stage of the MPEG encoder 103. The input (IN) block 201 also performs parity check.

A header (MAKE HEADER) block 202 stores MPEG headers such as sequence_header, quantizer_matrix, and gop_header in the main memory 203 utilizing vertical blanking (V Blanking) intervals of the input video (VIDEO IN) data. These headers are specified primarily by a CPU interface (CPU I/F) block 221.

In the intervals other than vertical blanking (V Blanking) intervals, video data (VIDEO DATA) received from the input (IN) block 201 is stored in the main memory 203.

The main memory 203 serves as a frame memory for images, and executes such operations as reordering of data and absorption of system delay. The magnitudes of delay shown in FIG. 2 represent read timing, which are appropriately controlled based on the instructions issued from a timing generator (TG) block 220.

A luster-block scan conversion (LUSTER SCAN→BLOCK SCAN) block 204 extracts the image data by macroblock to be used in MPEG encoding from video data (VIDEO DATA) stored in the main memory (MAIN MEMORY) 203 for each line (Line), and send it to subsequent blocks.

A macroblock to be used in MPEG encoding is a matrix of 16 pixels by 16 lines. In the example shown herein, only the first field is used to obtain the activity, so that processing of data may be started at the point in time the first 8 lines of the first field are stored in the main memory 203. In actuality, the processing is started appropriately upon receipt of an instruction from the timing generator (TG) block 220.

An activity (ACTIVITY) block 205 calculates the activity of each macroblock. It should be noted, however, that in the example shown herein, the activity is calculated only from the first field, which is transferred as an field activity signal (field_act). In this embodiment, in calculating the activity from only the first field, it is calculated in unit of sub-block consisting of 32 pixels (=8 pixels×4 lines).

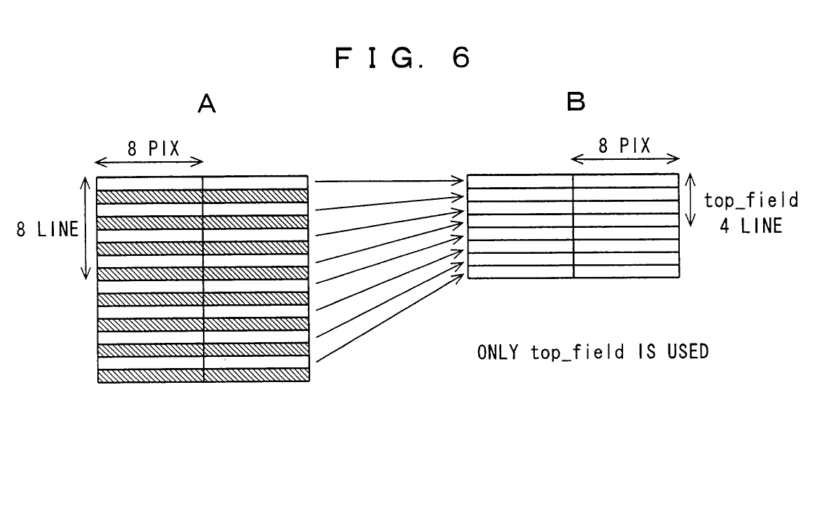

In FIG. 6, “A” shows one macroblock of 16 pixels×16 lines. This macroblock is further divided into DCT blocks each consisting of 8 pixels and 8 lines. In FIG. 6, B shows four sub-blocks each having 8 pixels×4 lines extracted only the components in first field (top_field) from the DCT blocks. Field activity (field_act) of each sub-block is calculated based on the following operations

First, the average value (P) of the luminance levels (Yk) of each of the pixels every sub-blocks (8 pixel×4 lines) is calculated, using the following equation.

P=1/32Σ[k=1, 32]Yk (1)

That is, the average (P) is obtained by dividing by 32 the sum of luminance levels (Yk) of 32 pixels in the sub-block.

Next, an average variance (var_sblk) is obtained according to the following equation for each of the sub-blocks (8 pixel×4 lines) by squaring the difference between the respective luminance levels (Yk) and the average (P), summing them over all the sub-blocks, and dividing the sum by 32.

var_{—}sblk=1/32Σ[k=1,32](Yk−P)² (2)

Next, since one macroblock consists of four sub-blocks, the least one of the four average variances (var_sblk) is determined for each macroblock. As seen in Equation (3), the least variance is used to define the field activity (field_act) of the macroblock.

(field_act)=1+min[sblk=1,4](var_sblk) (3)

Referring back to FIG. 2, an activity averaging (AVG_ACT) block 206 accumulates the field activities (field_act) calculated by the activity block 205 for each of the macroblocks based on only the first field (top field) for the period of the first field (top_field) and obtains the average activity (avg_act) defined by Equation (4) below.

avg_act=1/MBnumΣ[m=1, MBnum](field_act)(m) (4)

where Mbnum is the total number of macroblocks in one frame.

The activity averaging (AVG_ACT) block 206 transfers the average activity (avg_act) to an activity (ACTIVITY) block 209 to execute a pre-encoding (Pre Encode) processing, using the average activity (avg_act). Thus, after the average activity (avg_act) in the first field is found, the pre-encoding processing can be executed taking account of appropriate adaptive quantization using the average activity.

Further, the pre-encoding processing section 103B will be described.

The luster-block scan conversion block (LUSTER SCAN→BLOCK SCAN) 207A is basically the same as the luster-block scan conversion block 204. However, the luster-block scan conversion block 207A is provided for performing pre-encoding processing (PRE_ENCODE) which requires not only the first field data but also the second field data.

Hence, at the time when eight lines of the second field are stored in the main memory (MAIN MEMORY) 203, a macroblock of 16 by 16 pixels necessary for MPEG encoding can be constructed, so that the MPEG encoding can be started at this point. In actuality, the MPEG processing is properly started by an instruction received from the timing generator (TG) block 220.

A DCT mode (DDCT MODE) block 208 determines which of the field DCT encoding mode or the frame DCT encoding mode be used for the current encoding. In this block, encoding is not performed, but a comparison is made between the sum of absolute value of the variances of vertically neighboring pixels calculated in the field DCT encoding mode and that calculated in the frame DCT encoding mode. As a result of the comparison, the mode that gives the least variance is chosen as the encoding mode. The chosen encoding mode is inserted as DCT mode type data (dct_typ) in the form of a temporary flag in the stream for later use by the subsequent stages.

The activity (ACTIVITY) block 209 is basically the same as the activity block 205. However, the activity block 209 is provided to perform the pre-encoding (Pre_Encode) processing as stated previously, which requires not only the first field data but also the second field data to calculate the activities for each of the macroblocks.

Using the average activity (avg_act) obtained by the activity averaging (AVG_ACT) block 206, a normalized activity (norm_act) for the current frame may be obtained by Equation (5) below.

norm_act(m)={norm_gain×act(m)+avg_act}÷{act(m)+norm_gain×avg_act} (5)

where act(m) is the activity of a macroblock having macroblock address m, norm_gain is a normalized coefficient calculated in correspondence with the average activity (avg_act). The norm_gain can be obtained by Equation (6) below, using a predetermined parameter att. The normalized coefficient (norm_gain) permits determination of the range of normalization that takes account of activity fluctuations in the respective frames. The parameter att is given as value 0.125, for example.

norm_gain=att×avg_act+1 (6)

In Equation (5), the value of the norm_act(m) is fixed at 1 when the terms, act(m) and avg_act are both zero since the denominator of Equation (5) becomes zero if so. In this way, the normalized activity (norm_act) thus obtained is temporarily inserted into the stream as a flag, which can be used by the subsequent stages.

The DCT conversion (DCT) block 210A performs two-dimensional DCT (discrete cosine transformation). This two-dimensional DCT is carried out for each of the 8×8 DCT blocks. The results of the conversion, DCT coefficients, are transferred to a Q table (Q Table) block 211A.

The Q table (Q Table) block 211A performs quantization on DCT coefficients obtained in the DCT conversion block 210A using a quantizer matrix (quntizer_matrix).

A multi-stage quantization block includes a multiplicity of quantization (Q_n) blocks 212, a multiplicity of VLC blocks 213, and a multiplicity of accumulation (Σ) blocks 214 and 215. The multi-stage quantization block performs multi-stage quantization on DCT coefficients obtained by a Q table (Q_Table) block 211A.

The respective Q n blocks 212 are adapted to perform quantization on the DCT coefficients using different quantizer scales (quantizer_scale) Q. It is noted that the magnitude Q of the quantizer scale (quantizer_scale) is previously determined based on, for example, MPEG2 standard. As an example, each of the Q n blocks 212 may consist of 31 quantizers based on this standard. Each of the quantizers performs quantization on the DCT coefficients using a quantizer scale Q assigned to each of them. Thus, there will be a total of 31 quantization steps.

The VLC blocks 213 are provided in association with the quantizers of the respective quantization (Q_n) blocks 212 such that the VLC blocks carry out scanning, e.g. zigzag scanning, on the respective DCT coefficients obtained by the respective quantizers and perform variable-length encoding on the scanned DCT coefficients using, for example, Huffman codes.

Each of the accumulation (Σ) blocks 214 accumulates the amount of encoded data (said amount of encoded data hereinafter referred to as AED) generated in the corresponding VLC block 213 through the variable-length encoding, and inserts into the stream the resultant AED value (mb_data_rate) as a temporally flag representing the generated AED for each of the macroblocks, which can be used in subsequent stages. It will be understood that when 31 kinds of quantizers are used as described above, there will be 31 kinds of AEDs generated with one kind for each macroblock.

A quantizer scale (mquant) that takes account of visual characteristics is calculated by

mquant=Q_{—}n×norm_act

where the norm_act is the normalized activity obtained in the activity block 209. Each of the accumulation (Σ) blocks 215 selects AED corresponding to the generated AED for each of the macroblocks quantized using this quantizer scale (mquant) from the AEDs obtained in the block 214 for each of the macroblocks, and accumulates the selected value for one flame to obtain total amount of encoded data generated (referred to as frame data rate).

The frame data rate is transferred to a rate control block 217 as the encoded data generated for the frame. It will be understood that when 31 kinds of quantizers are used as described above, there will be 31 kinds of AEDs corresponding thereto for each of the macroblocks.

Next, an encode processing section 103C will be described. After the frame data rate is found by the above pre-encoding, a final encoding is performed so that the encode processing section 103C outputs the MPEG streams (MPG STREAM) that never exceed a given target AED.

The luster-block conversion (LUSTER SCAN→BLOCK SCAN) block 207B is the same as the luster-block conversion (LUSTER SCAN BLOCK SCAN) block 207A of the pre-encoding processing section 103B described above. It will be recalled that the data necessary for the luster-block conversion has been already stored in the main memory 203. However, this processing can be started at the point when the frame data rate is found after completion of pre-encoding. In actuality, the processing is properly started by an instruction received from the timing generator (TG) block 220.

Like the DCT mode (DCT MODE) block 208 of the pre-encoding processing section 103B, a DCT mode (DCT MODE) block 216 determines which of the field DCT encoding mode or the frame DCT encoding mode be used for the encoding.

However, since in this instance the DCT mode type data (dct_typ) has been already inserted into the stream in the DCT mode block (Mode) 208, the DCT mode (DCT MODE) block 216 detects the DCT mode type data (dct_typ), switches the mode between the field DCT encoding mode and the frame DCT encoding mode in accord with the DCT mode type data (dct_typ), and transfers it to the subsequent stages.

A DCT block 210B is exactly the same as the DCT conversion block 210A of the pre-encoding processing section 103B, and performs two-dimensional DCT for each of the 8×8 pixels.

A Q table (Q_Table) block 211B can be exactly the same in structure as the Q table (Q_Table) block 211A so as to perform quantization using a quantizer matrix (quntizer_matrix) on the DCT coefficients obtained in the DCT block 210B.

A rate control (Rate Control) block 217 selects, out of multiple frame data rates obtained by a multiple of quantizers of the accumulation (Σ) blocks 215 of the pre-encoding section 103B, the one which does not exceed, but closest to, the maximum generated AED value for each frame set by the CPU interface block 221. The rate control (Rate Control) block 217 again obtains, from the normalized activity (norm_act) inserted into the stream, the quantizer scale (mquant) for each of the macroblocks which have used by the corresponding quantizers, and transfers it to a Q block 218.

In the procedure described above, it is possible to realize a high-quality picture by setting the quantizer scale (mquant) to the value less than the maximum generated AED value set by the CPU interface block CPU I/F 221 by 1 every macroblocks unless it exceeds the difference between the maximum generated AED value for one frame set by the CPU interface block 221 and the selected quantizer scale (mquant), so that the quantizer scale (mquant) can be as close as possible to the maximum generated AED value for one frame.

The Q block 218 performs quantization using a quantizer scale (quantizer scale) instructed by a rate control (RATE-CONTROL) block 217. The quantizer scale (quantizer_scale) used in this point is the value (mquant) obtained from the activity, so that the Q block 218 performs adapted quantization which takes account of visual characteristics of the picture area used.

A VLC block 219 receives DCT coefficients obtained by the quantizer of the Q block 218, carries out scanning, e.g. zigzag scanning, on the DCT coefficients and then performs variable-length encoding on it using Huffman coding. The VLC block 219 further executes bit-shifting to reorder the variable-length coded DCT coefficients every bytes, and outputs MPEG stream (MPEG STREAM OUTPUT).

The timing generator (TG) block 220 generates various timing signals required by the MPEG encoder 103 using horizontal synchronization (HD) signal, vertical synchronization (VD) signal, and field (FLD) signal in phase with the input video data (VIDEO Data Input), and distributes these timing signals to the blocks requiring the signals.

The CPU interface block 221 communicates with a higher level system controller through exchange of such signals as STRB, STAT, CS, and DATA to set up a mode for the MPEG encoders 103 and provides necessary headers. The CPU interface block 221 also reports the status of the MPEG encoders 103 to enable the higher-level system controller to monitor MPEG encoding.

Although the MPEG encoder 103 has been described above as hardware, the encoding can be alternatively attained by software.

In the embodiment described above, when the SDTI In signal is an SD signal (according to 525/60i signal standard), only the MPEG encoder (MPEG_ENCI) 103-1 intra-encodes the active video data of video input (VIDEO IN) signal. On the other hand, when the SDI In signal is an HD signal (according to 1125/60i signal standard), MPEG encoder (MPEG_ENC1) 103-1 and MPEG encoder (MPEG_ENC2) 103-2 intra-encode the video input (VIDEO IN) signal. Accordingly, proper recording data can be obtained through MPEG encoding irrespective of whether the SDI In signal is SD signal or HD signal. It should be appreciated that a compact and less expensive MPEG encoders 103-1 and 103-2 for SD signal can be used for HD SDI In signal.

In accordance with the embodiment, when the SDTI In signal is an HD signal, the MPEG encoder 103-1 intra-encodes the image data extracted from activity video data of the video input (VIDEO IN) signal corresponding to the first group of divisional domains (first, third, fifth, . . . divisional domains distributed over the picture area in the horizontal direction, each having a width of 16 pixels) of the picture area. The MPEG encoder 103-2 also intra-encodes the image data extracted from activity video data of the video input (VIDEO IN) signal corresponding to the second group of divisional domains (second, fourth, sixth, . . . divisional domains distributed over the picture area in the horizontal direction, each having a width of 16 pixels). Thus, the encoders 103-1 and 103-2 carry out image processing on portions of the image data having similar complexity in parallel. Even if a target encoding task is uniformly allocated to each of the encoders 103-1 and 103-2, each encoder encodes the image data in parallel with each other to obtain the image with similar image quality, thereby preventing therefrom undesirable conspicuous peripheral boundaries of the divisional picture domains.

Although, in the above embodiments, the picture area has been vertically divided into divisional picture domains having a width of 16 pixels positioned in the horizontal direction, the width may alternatively be doubled or tripled. Furthermore, the picture area may alternatively be horizontally divided into divisional picture domains of 16 lines positioned in a vertical direction, as shown in FIG. 5B, or horizontally as well as vertically divided into divisional picture domains as shown in FIG. 5C.

In a case where the picture area is horizontally divided into divisional picture domains positioned in the vertical direction as shown in FIG. 5B, it is then necessary to provide buffers dealing with 16 lines of pixels extending over the length (width) of the picture area. This causes more complex hardware to be implemented therein as compared with the case where the picture area is vertically divided into divisional picture domains positioned in the horizontal direction as shown in FIG. 5A. In a case where division is made as shown in FIG. 5C, although address processing in the circuit for division is very complex, the arrangement will be ideal from the point of encoding quality.

In short, it suffices in the invention that each of the groups of divisional picture domains occurs in turn within the picture area. In other words, the centers of gravity of the respective groups within the entire picture area substantially coincide. In other words, if taking the centers of gravity of the plural divisional picture domains in the respective groups, the taken centers of gravity between the respective groups substantially coincide.

In the preferred embodiments, the picture area is divided into first and second groups of divisional picture domains which distributed over the picture area, and then the activity video data of the video input (VIDEO IN) data corresponding to each of the first and second groups is intra-encoded by the first and/or second encoders 103-1 and 103-2, respectively. It will be apparent that the picture area can be divided into more than two groups and intra-encoded using more than two encoders.

The invention has been described with preferred embodiments of an MPEG-VTR. However, the invention is not limited thereto, it may be applied not only to recording of image data but also to transmission of image data.

The appended claims therefore are intended to cover all such modifications as fall in the true scope and spirit of the invention.

What is claimed is:

1. An encoding apparatus for encoding input image data to obtain encoded output image data, said encoding apparatus comprising:
first through Nth encoders each for extracting image data from the input image data and intra-encoding the image data, said extracted image data corresponding to each of the first through Nth groups, each group having multiple divisional picture domains in a given picture area, said multiple divisional picture domains of every group being distributed over the picture area, each of said first through Nth groups of the divisional picture domains occurring in turn within the picture area; and
a data combiner for receiving the intra-encoded image data from each of said first through Nth encoders and combining the received intra-encoded image data to obtain the encoded output image data.

2. The encoding apparatus according to claim 1, wherein centers of gravity of said first through Nth groups of divisional picture domains within the entire picture area substantially coincide.

3. The encoding apparatus according to claim 1, wherein said first through Nth encoders respectively perform data-compression and encoding on said image data through discrete cosine transformation, quantization, and variable-length encoding.

4. The encoding apparatus according to claim 1, wherein said divisional picture domains are obtained by dividing said picture area in a horizontal direction.

5. The encoding apparatus according to claim 1, wherein said divisional picture domains are obtained by dividing said picture area in a vertical direction.

6. The encoding apparatus according to claim 1, wherein said divisional picture domains are obtained by dividing said picture area in horizontal and vertical directions.

7. The encoding apparatus according to claim 1, wherein said divisional picture domains of the same group are not neighbored with each other.

8. A method for encoding input image data to obtain encoded output image data, said method comprising the steps of:
extracting image data from the input image data;
intra-encoding the image data thus extracted every first through Nth groups, each group having multiple divisional picture domains in a given picture area, said extracted image data corresponding to each of the first through Nth groups of multiple divisional picture domains in a given picture area, said multiple divisional picture domains of every group being distributed over the picture area, each of the first through Nth groups of multiple divisional picture domains occurring in turn within the picture area; and
combining the data thus intra-encoded every first through Nth groups to obtain the encoded output image data.

9. An encoding apparatus for encoding input image data to obtain encoded output image data, said encoding apparatus comprising:
first and second encoders each for intra-encoding image data;
a controller for controlling said first and second encoders to cause said first encoder to intra-encode said input image data when the input image data is of a first picture quality, and to causes the first and second encoders to intra-encode said image data extracted from said input image data with the extracted image data corresponding to each of the first and second groups when said input image data is of a second picture quality higher than the first picture quality, each group having multiple divisional picture domains of a picture area, said multiple divisional picture domains of both groups being distributed over the picture area, each of the first and second groups of multiple divisional picture domains occurring in turn within the picture area; and
an encoded-image-data-outputting device for outputting as the encoded output image data the encoded data received from the first encoder when the input data is of the first picture quality, and for combining the encoded data received from the first and second encoders and outputting the combined data as the encoded output image data when the input image data is of the second picture quality.

10. A method for encoding input image data to obtain encoded output image data, said method comprising the step of:
intra-encoding said input image data when the input image data is of a first picture quality, and extracting image data from input image data and intra-encoding the image data thus extracted for each of the first and second groups when said input image data is of a second picture quality higher than the first picture quality, said extracted image data corresponding to each of the first and second groups, each group having multiple divisional picture domains of a picture area, said multiple divisional picture domains of the first and second groups being distributed over the picture area, each of said first and second groups of multiple divisional picture domains occurring in turn within the picture area, and combining the encoded data thus intra-coded for each of the first and second groups when said input image data is of the second picture quality; and
outputting the data thus intra-encoded as said encoded output image data when the input image data is of the first picture quality, and the combined data as said encoded output image data when said input image data is of the second picture quality.
